(19) United States
(12) Patent Application Publication
(10) Pub. No.: US 2012/0268331 A1
(43) Pub. Date: Oct. 25, 2012

(54) SMALL ANTENNA FOR VEHICLE

(76) Inventors: Tae Hoon YANG, Incheon (KR); Woo Jin KIM, Pyeongtaek-si (KR)

(21) Appl. No.: 13/365,797

(22) Filed: Feb. 3, 2012

(30) Foreign Application Priority Data
Feb. 9, 2011 (KR) 10-2011-0011473

(51) Int. Cl. H01Q 1/27

(52) U.S. Cl. 343/711

(57) ABSTRACT

A small antenna for vehicle comprises a coil member of helical antenna structure with a plurality of coils formed; a connector disposed at one end of the coil member; a signal pin contacting with the connector; a cylindrical member coupled to the other end of the coil member and made of metal material; a dielectric body inserted inside the coil member and cylindrical member and disposed adjacent to the connector and signal pin; a conductor inserted inside the coil member and cylindrical member and disposed at one end of the dielectric body; and a cover member enclosing the coil member and cylindrical member inside which the dielectric body and conductor are inserted.

### CROSS REFERENCE

This application claims foreign priority under Paris Convention to Korean Patent Application No. 10-2011-0011473, filed Feb. 9, 2011 with the Korean Intellectual Property Office, where the entire contents are incorporated herein in its entirety.

### BACKGROUND OF THE INVENTION

1. Field of the Invention

The present invention relates to a small antenna for vehicle, more specifically, a small antenna for vehicle wherein by inserting a dielectric body and conductor inside a coil member and at the same time disposing a cylindrical member made of metal material at one end of the coil member, the antenna can enhance the electrical properties(gain, directivity etc.) to thereby obtain the signal reception performance over a fixed level, while reducing the length of the antenna.

2. Background of the Invention

Generally used in a vehicle is a pole-type helical antenna which allows a radio in the vehicle to receive signals.

In this regard, the conventional pole-type helical antenna is an antenna having a spiral coil structure such that resonance may be generated at a shorter length than antenna length(λ/4), and such a helical antenna exhibits a resonance at a specific frequency according to the length and pitch etc.

In general, the conventional pole-type helical antenna for vehicle has a length of about 180˜220 mm for smoothly receiving signal of frequency of AM/FM band.

However, the conventional pole-type helical antenna has a disadvantage that its length is too long to conform to the design of the vehicle currently launched in the market, and a problem that if the length of the pole-type helical antenna is short, smooth reception of frequency signal is not possible.

Therefore, attempts have been made to develop a small antenna for vehicle which can smoothly receive the frequency signal while reducing the length of the conventional pole-type helical antenna and reduce cost for production of the antenna and at the same time has a compact structure considering the design of the vehicle.

### SUMMARY OF THE INVENTION

The present invention has been devised for solving the above-mentioned problems, and its object is to provide a small antenna for vehicle wherein by inserting the dielectric body and conductor inside the coil member of helical antenna structure and at the same time disposing the cylindrical member made of metal material at one end of the coil member, the small antenna for vehicle according to the present invention can enhance the electrical properties(gain, directivity etc.) to thereby obtain the signal reception performance over a fixed level, while reducing the length of the antenna.

Another object of the present invention is to provide a small antenna for vehicle which can receive the frequency of TDMB or DAB [symbol] band by means of the resonance due to coupling phenomenon of the signal pin contacting with the connector, and the dielectric body and conductor.

Yet another object of the present invention is to provide a small antenna for vehicle which can reduce cost for production of the antenna and at the same time have a compact external appearance conforming to the design of the vehicle by reducing the length of the antenna and can multiply receive signals of frequency of radio band and TDMB or DAB [symbol] band.

The above-mentioned objects of the present invention are achieved according to the present invention by a small antenna for vehicle, comprising a coil member of helical antenna structure with a plurality of coils formed, a connector disposed at one end of the coil member; a signal pin contacting with the connector; a cylindrical member coupled to the other end of the coil member and made of metal material; a dielectric body inserted inside the coil member and cylindrical member and disposed adjacent to the connector and signal pin; a conductor inserted inside the coil member and cylindrical member and disposed at one end of the dielectric body; and a cover member enclosing the coil member and cylindrical member inside which the dielectric body and conductor are inserted, wherein the cover member has a length of 110˜130 mm, a frequency of radio band is received through the dielectric body, coil member and cylindrical member, a frequency of TDMB(Terrestrial Digital Multimedia Broadcasting) or DAB [symbol] (Digital Audio Broadcasting Band [symbol] ) band is received by means of resonance due to coupling phenomenon of the dielectric body and conductor, and the signal pin receives frequency of band for mobile communication.

Here, the coil member has a length of 60˜80 mm, the cylindrical member has a length of 20˜40 mm, and the ratio of the length of the coil member to that of the cylindrical member may be 6:4 to 8:2.

Furthermore, the cylindrical member may be made of conductive metal material with electrical properties, and made of copper or aluminum material.

Here, the conductor is made of any one of coaxial cable, copper and SUS(Steel Use Stainless), and the dielectric body may be made of POM(Poly Oxy Methylene) or Poly Acetal.

Meanwhile, in the small antenna for vehicle, tuning value of signal reception band is adjusted according to the lengths of the dielectric body and conductor, and the ratio of the length of the dielectric body to that of the conductor may be 5:5 to 7:3.

According to the present invention, by inserting the dielectric body and conductor inside the coil member of helical antenna structure and at the same time disposing the cylindrical member made of metal material at one end of the coil member, the small antenna for vehicle according to the present invention can enhance the electrical properties(gain, directivity etc.) to thereby obtain the signal reception performance over a fixed level, while reducing the length of the antenna.

Furthermore, the small antenna for vehicle can receive the frequency of TDMB or DAB [symbol] band by means of the resonance due to coupling phenomenon of the signal pin contacting with the connector, and the dielectric body and conductor.

Furthermore, by reducing the length of the antenna, cost for production of the antenna can be reduced and at the same time a compact external appearance conforming to the design of the vehicle can be obtained, and signals of frequency of radio band and TDMB or DAB [symbol] band can be received multiply.

### BRIEF DESCRIPTION OF THE DRAWING

The attached drawings have a purpose of facilitating the understanding of the technical concepts of the present invention along with the above detailed description of the invention, and thus the present invention should not be interpreted as being limited to the matters illustrated in the attached drawings.

FIG. 1 is a exploded perspective view illustrating a small antenna for vehicle according to the present invention.

FIG. 2 is a graph comparing the signal reception performances of the small antenna for vehicle according to the present invention and the conventional pole-type antenna having a 200 mm length.

* LISTS OF REFERNECE NUMERALS IN THE DRAWINGS *

| | |
|---|---|
| 10: coil member | 20: connector |
| 30: dielectric body | 40: cylindrical member |
| 50: cover member | 60: conductor |
| 70: signal pin | 100: small antenna for vehicle |

D1: the sum of the lengths of the coil member and cylindrical
member
D2: the length of the cylindrical member

### DETAILED DESCRIPTION OF EXEMPLARY EMBODIMENTS

Hereinafter, constructions of the present invention will be described in detail with reference to the attached drawings.

Prior to description, it should be noted that terms used in the specification and claims should not be limitedly interpreted as lexical meanings, but should be interpreted as meanings and concepts coinciding to technical concepts of the present invention based on the principle that inventors may properly define the concepts of the terms in order to explain their inventions in a best way.

Therefore, examples described in the specification and constructions illustrated in the drawings are only preferred examples of the present invention, and do not represent all of the technical concepts of the present invention, and thus it should be understood that various equalities and modifications may be present which can replace them at the time of application of the present invention.

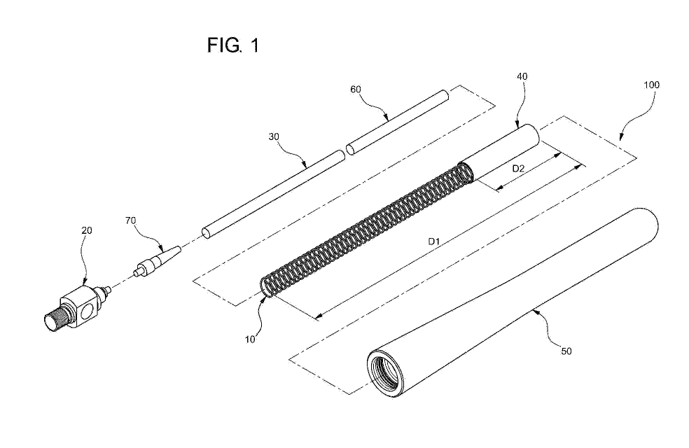

FIG. 1 is a exploded perspective view illustrating a small antenna for vehicle according to the present invention.

Referring to FIG. 1, the small antenna (100) for vehicle according to the present invention comprises a coil member (10) of helical antenna structure with a plurality of coils formed; a connector (20) disposed at one end of the coil member (10); a signal pin (70) contacting with the connector (20); a cylindrical member (40) coupled to the other end of the coil member (10) and made of metal material; a dielectric body (30) inserted inside the coil member (10) and cylindrical member (40) and disposed adjacent to the connector (20) and signal pin (70); a conductor (60) inserted inside the coil member (10) and cylindrical member (40) and disposed at one end of the dielectric body (30); and a cover member (50) enclosing the coil member (10) and cylindrical member (40) inside which the dielectric body (30) and conductor (60) are inserted, wherein the cover member (50) has a length of 110˜130 mm, a frequency of radio band is received through the dielectric body (30), coil member (10) and cylindrical member (40), a frequency of TDMB(Terrestrial Digital Multimedia Broadcasting) or DAB [symbol] (Digital Audio Broadcasting Band [symbol] ) band is received by means of resonance due to coupling phenomenon of the dielectric body (30) and conductor (60), and the signal pin (70) may receive frequency of band for mobile communication.

Here, the coil member (10) is a component which serves to receive the frequency of radio band by means of the resonance through the cylindrical member (40) and dielectric body (30), and may be provided as a spring with coil pitch wound, as shown in FIG. 1.

Furthermore, the coil member (10) serves to transmit the received frequency signal by contacting with the connector (20).

Here, the connector (20) is a component which serves to connect the frequency signal transmitted from the coil member (10) to a variety of equipment at rear end.

Here, the signal pin (70) is a component which serves as an antenna for receiving the frequency of band for mobile communication, and the dielectric body (30) and conductor (60) are components which receive the frequency of TDMB(Terrestrial Digital Multimedia Broadcasting) or DAB [symbol] (Digital Audio Broadcasting Band [symbol] ) band by means of the coupling resonance.

Here, as shown in FIG. 1, the signal pin (70) contacts with one end of the connector (20), and a portion of the signal pin (70) may be inserted into the coil member (10).

Furthermore, the dielectric body (30) and conductor (60) are components inserted in inner space defined by the coil member (10) and cylindrical member (40), and serve to transmit the received frequency signal to the connector (20) by means of the resonance and at the same time support the coil member (10) to prevent a play thereof, thereby enhancing a signal receiving rate of the antenna.

Here, as shown in FIG. 1, the dielectric body (30) is inserted in the inner space of the coil member (10) and disposed adjacent to the connector (20), and the conductor (60) is disposed at one end of the dielectric body (30) and the coil member (10) has a length of 60˜80 mm.

Here, if the length of the coil member (10) is less than 60 mm, frequency reception performance is reduced, and the length of the coil member (10) is more than 80 mm, the total length of the antenna is increased.

Furthermore, the dielectric body (30) may be made of any one of polyoxymethylene or acetal polymer and may be in the form of a bar with a constant length.

Here, the polyoxymethylene or acetal polymer are engineering plastics that are excellent in mechanical properties, such as fatigue resistance, toughness, wear resistance etc., which are not exhibited in another material, and have permittivity of more than a fixed level.

Furthermore, the conductor (60) may be made of any one of coaxial cable, copper and SUS(Steel Use Stainless), preferably the coaxial cable.

Here, the coaxial cable is a transmission line consisting of a long cylindrical outer conductor and one inner conductor arranged on central axis thereof, and the inner and outer conductors are concentric with each other as viewed in a cross section, and a space between the inner and outer conductors is filled with resin, and the outer conductor is covered with a sheath.

Here, in the small antenna for vehicle, tuning value of signal reception band is adjusted according to the lengths of the dielectric body (30) and conductor (60), and the ratio of the length of the dielectric body (30) to that of the conductor (60) is 5:5 to 7:3, preferably 6:4.

Meanwhile, the cylindrical member (40) is a component coupled to the other end of the coil member (10), as shown is FIG. 1, and is in the form of a cylinder made of conductive metal material with electrical properties, and with the dielectric body (30) and conductor (60) inserted inside the coil member (10) and cylindrical member (40), the dielectric body (30), conductor (60), coil member (10) and cylindrical member (40) can be resonated to receive a signal of radio frequency band.

Furthermore, with the dielectric body (30) and conductor (60) disposed inside the coil member (10) and cylindrical member (40), the small antenna (100) for vehicle according to the present invention can have enhanced electrical properties(gain, directivity), whereby a smooth reception of signal can be realized while the length of the antenna is reduced.

Here, the length(D2) of the cylindrical member (40) may be 20˜40 mm, wherein if the length of the cylindrical member (40) is less than 20 mm, the frequency reception performance is reduced, and if the length of the cylindrical member (40) is more than 40 mm, the total length of the antenna is increased.

That is to say, the ratio of the length of the coil member (10) to that of the cylindrical member (40) may be 6:4 to 8:2.

As described above, the sum(D1) of the lengths of the coil member (10) and cylindrical member (40) may be in a range of 80˜120 mm, and thus the length of the conventional pole-type antenna of about 200 mm can be drastically decreased.

That is to say, the small antenna (100) for vehicle according to the present invention may be embodied by disposing the connector (20) and signal pin (70) at one end of the coil member (10), coupling the cylindrical member (40) to the other end of the coil member (10), inserting the dielectric body (30) and conductor (60) inside the coil member (10) and cylindrical member (40) and assembling these all components inside the cover member (50).

Furthermore, the small antenna (100) for vehicle may be adapted to simultaneously receive the frequency of TDMB or DAB [symbol] band by means of the secondary resonance due to coupling phenomenon of the dielectric body (30) and conductor (60) and the tuning.

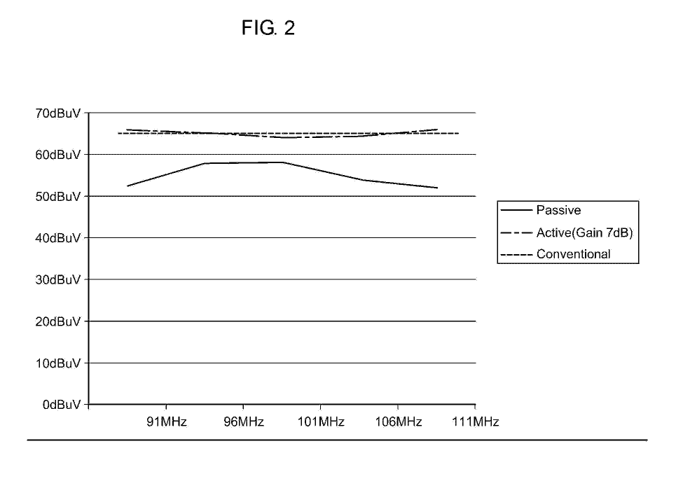

In the following, referring to FIG. 2, the signal reception performances of the small antenna for vehicle according to the present invention and the conventional pole-type antenna will be described in more detail.

FIG. 2 is a graph comparing the signal reception performances of the small antenna for vehicle according to the present invention and the conventional pole-type antenna having a 200 mm length.

Referring to FIG. 2, the small antenna (100) for vehicle according to the present invention exhibits electrical properties (gain, directivity) approximately equal to the conventional pole-type antenna having a 200 mm length over the whole band of frequency from 88 MHz to 108 MHz.

Therefore, it can be recognized that the signal reception performance of the small antenna for vehicle according to the present invention is not decreased over FM frequency band, compared to the conventional pole-type antenna.

As described above, by inserting the dielectric body and conductor inside the coil member of helical antenna structure and at the same time disposing the cylindrical member made of metal material at one end of the coil member, the small antenna for vehicle according to the present invention can enhance the electrical properties(gain, directivity etc.) to thereby obtain the signal reception performance over a fixed level, while reducing the length of the antenna.

Furthermore, the small antenna for vehicle can receive the frequency of TDMB or DAB [symbol] band by means of the resonance due to coupling phenomenon of the signal pin contacting with the connector, and the dielectric body and conductor.

Furthermore, by reducing the length of the antenna, cost for production of the antenna can be reduced and at the same time a compact external appearance conforming to the design of the vehicle can be obtained, and signals of frequency of radio band and TDMB or DAB [symbol] band can be received multiply.

As mentioned above, though the present invention has been described with the specific examples and drawings, its technical concepts are not limited to them, and therefore the persons having ordinary skills in the art may carry out the present invention in other way by various modifications and alterations thereof without departing from the technical concepts of the present invention and equalities of the following claims.

What is claimed:

1. A small antenna for vehicle, comprising:
a coil member of helical antenna structure with a plurality of coils formed;
a connector disposed at one end of the coil member;
a signal pin contacting with the connector;
a cylindrical member coupled to the other end of the coil member and made of metal material;
a dielectric body inserted inside the coil member and cylindrical member and disposed adjacent to the connector and signal pin;
a conductor inserted inside the coil member and cylindrical member and disposed at one end of the dielectric body; and
a cover member enclosing the coil member and cylindrical member inside which the dielectric body and conductor are inserted,
wherein the cover member has a length of 110˜130 mm, a frequency of radio band is received through the dielectric body, coil member and cylindrical member, a frequency of TDMB(Terrestrial Digital Multimedia Broadcasting) or DAB [symbol] (Digital Audio Broadcasting Band [symbol] ) band is received by means of resonance due to coupling phenomenon of the dielectric body and conductor, and the signal pin receives frequency of band for mobile communication.

2. The small antenna for vehicle according to claim 1, wherein the coil member has a length of 60˜80 mm, the cylindrical member has a length of 20˜40 mm, and the ratio of the length of the coil member to that of the cylindrical member is 6:4 to 8:2.

3. The small antenna for vehicle according to claim 1, wherein the cylindrical member is made of conductive metal material with electrical properties, and made of copper or aluminum material.

4. The small antenna for vehicle according to claim 1, wherein the conductor is made of any one of coaxial cable, copper and SUS(Steel Use Stainless), and the dielectric body is made of POM(Poly Oxy Methylene) or Poly Acetal.

5. The small antenna for vehicle according to claim 1, wherein, in the small antenna for vehicle, tuning value of signal reception band is adjusted according to the lengths of the dielectric body and conductor, and the ratio of the length of the dielectric body to that of the conductor is 5:5 to 7:3.
